(19) United States
(12) Patent Application Publication
(10) Pub. No.: US 2019/0359025 A1
(43) Pub. Date: Nov. 28, 2019

(54) ACTIVE SUSPENSION CONTROL SYSTEM AND METHOD FOR NO-ROAD VEHICLES

(71) Applicant: KELSO TECHNOLOGIES INC., Surrey (CA)

(72) Inventor: Gebhard Charles WAGER, Kelowna (CA)

(21) Appl. No.: 16/482,919

(22) PCT Filed: Jan. 31, 2018
(86) PCT No.: PCT/CA2018/000019

§ 371 Date: Aug. 1, 2019

Related U.S. Application Data
(60) Provisional application No. 62/454,422, filed on Feb. 3, 2017.

(30) Foreign Application Priority Data
Feb. 3, 2017 (CA) 2956933

(51) Int. Cl. B60G 21/06; B60G 17/0165

(52) U.S. Cl. CPC B60G 21/06; B60G 17/0165; B60G 2300/07; B60G 2800/9124; B60G 2500/30; B60G 2800/014; B60G 2400/82

(57) ABSTRACT

An active suspension control system and method for individually controlling a suspension assembly of each wheel of a vehicle in response to driving conditions, each suspension assembly including an adjustable suspension spring having a hollow, fluidically sealed cylinder and a piston having a shaft and a head, the cylinder having an upper chamber divided from a lower chamber by the piston head, the lower chamber being adjacent to the piston shaft coupled to the corresponding wheel assembly, each chamber of the upper and lower chambers of the suspension spring having a port fluidly coupled to a fluid line and a valve of a valve assembly, wherein the extension or retraction of each adjustable suspension spring is controlled by an electronic controller by selectively introducing and/or removing a volume of a fluid from the upper and/or lower chambers of said adjustable suspension spring through the fluid line.

### CROSS REFERENCE TO RELATED APPLICATIONS

This application claims priority from U.S. Provisional Patent Application No. 62/454,422, filed on Feb. 3, 2017 and Canadian Patent Application No. 2,956,933, filed on Feb. 3, 2017, both entitled: “Active Suspension Control System and Method for No-Road Vehicles” entireties of which are incorporated herein by reference.

### TECHNICAL FIELD

This disclosure relates to suspension control systems and methods for vehicles. In particular, the disclosure relates to active suspension control systems and methods for adapting the suspension of a vehicle in response to off-road or no-road conditions.

### BACKGROUND

In both industry and leisure applications, it is often desirable to traverse rough terrain in a wheeled vehicle, such as a truck or in other forms of utility vehicles, for the purpose of reaching often remote destinations. For example, in the electrical powerline industry, conducting repair work on transmission lines may require transporting personnel and equipment to a remote mountain location that is not accessible by cleared roads. Other challenging terrain may include muddy conditions which present traction problems for a wheeled vehicle. In recreational and sport applications, off-road racing events often require participants to traverse rough terrain at higher speeds.

Conventional vehicle suspension systems are typically not capable of traversing such terrain, as climbing the vehicle over large obstacles such as fallen trees or boulders, combined with the uneven nature of the ground itself including ruts and ditches, while travelling either up, down or transversely across a slope, often causes each of the four wheels to be positioned at varying heights which may cause one or more wheels to lose contact with the ground, thereby often causing the vehicle to become immobilized, necessitating winching or the like to free the vehicle. Further problems are presented, for example, by travelling up or down slopes of 40° or greater, as modern suspension systems do not sufficiently adapt to compensate for the shifting center of gravity of a vehicle traversing such slopes, which may cause the vehicle to roll to the side or flip over the front or rear ends of the vehicle.

At present, for industrial applications requiring transport of personnel and equipment over rough terrain, businesses may utilize a vehicle having tracks instead of wheels to traverse the rough terrain; however, the disadvantage of using such vehicles is that they move slowly relative to wheeled vehicles, typically reaching top speeds of only 5 to 10 mph under such terrain conditions. As well, most track vehicles are unable to traverse steep slopes due to the weight of the vehicle not being evenly distributed across the tracks and the difficulty in gaining traction under such conditions, as well as the tendency of mud, rocks and other debris becoming entrapped within the track mechanism. Another option, either alone or in combination with tracked vehicles or regular trucks, is to use one or more All-Terrain Vehicles (ATVs) in order to transport personnel and equipment from a larger vehicle to the remote work site over the difficult terrain that cannot be traversed using the larger vehicle; however, this is a time-consuming process that may require several trips to complete, depending on the amount of equipment and personnel to be transported.

To the Applicant's knowledge, there are certain innovations existing in the prior art for actively controlling the suspension system of wheeled vehicles; however, these systems are typically directed to improving the comfort or performance of vehicles under typical driving conditions traversing a road. For example, the car manufacturer Mercedes-Benz™ markets an active suspension control system under the name Active Body Control™ (ABC), in which the suspension assembly includes a coil spring and damper connected in parallel, along with an hydraulic adjusting cylinder, whereby the adjusting cylinder is used to adjust the length of the suspension assembly. The adjusting cylinder is controlled by an electronic controller which receives input from various sensors on the vehicle and accordingly adjusts the length of the suspension assembly by controlling the hydraulic actuator. However, the ABC system, in Applicant's view, is complex, expensive and relatively heavy due to the use of powerful magnets. Furthermore, to the Applicant's knowledge, the ABC system has not been advertised for use in the rough terrain conditions described above.

Other road vehicles known to the Applicant offer various pre-set modes for tuning the suspension of the system, the pre-set modes being selected by the user for a given terrain. Such suspension systems may, to Applicant's knowledge, typically utilize a coil spring suspension combined with a hydraulic or pneumatically operated damper. In some systems, the damper component may contain a magnetorheological fluid which is capable of being adjusted for viscosity, thereby adjusting the stiffness of the damper, by applying or varying an electromagnetic field. However, again to the Applicant's knowledge, such systems only offer a finite number of suspension system settings and are typically not capable of dynamically adjusting components of the suspension system in response to changing terrain or driving conditions. For example, such systems may only include the ability to adjust the stiffness of the damper but not the spring, as a coil spring does not readily provide for adjustability. Other suspension systems may include the ability to adjust components of the suspension system in response to certain terrain conditions as detected by sensors on the vehicle, typically the damper; however, such systems are typically only capable of adjusting the suspension to one of a finite number of operating modes, which would in Applicant's view not be effective for crossing particularly rough terrain presenting large and unexpected obstacles, such as fallen trees or boulders.

Another active suspension system of which the Applicant is aware includes a system developed by Bose™ which utilizes electromagnetic struts to extend or retract each wheel independently of the other wheels. Although the Bose™ electromagnetic active suspension system was publicly revealed as early as 2004, to the knowledge of the Applicant this system has not been made commercially available due to the high cost of implementing such a system in a vehicle.

Thus, there exists a need for a cost-effective, lighter weight and otherwise improved active suspension control system and method for a wheeled vehicle that provides continuously variable adjustment of the components of the suspension system in response to detected changes in the terrain conditions, where the system is capable of enabling the vehicle to cross even rough terrain conditions.

### SUMMARY

In one aspect of the present disclosure, an active suspension control system and method is described which provides for individual, automatic adjustment of an adjustable suspension air spring for each wheel of a vehicle for a given terrain. Ideally, each spring may be substantially infinitely adjustable between the operational travel limits of each component, thereby improving the ability of the system to respond to and handle difficult obstacles and driving conditions that may be encountered by a no-road vehicle.

In one aspect of the present disclosure, the suspension assembly of each wheel is independently adjustable and consists of an adjustable suspension spring having at least two chambers, alternatively referred to herein as upper or “A” chambers and lower or “B” chambers, and an inlet/outlet valve for each chamber, whereby the pressure in either or both of the upper and lower chambers may be individually and independently adjusted by an electronically controlled valve block or other valve arrangement cooperating with an on-board processor. Advantageously, such a dual-chamber adjustable suspension air spring controlled by the processor in response to sensor inputs or user-selected pre-set operating modes enables both ride height adjustment of each individual wheel, as well as providing for forced (as opposed to passive) extension or retraction of the spring and/or adjusting the stiffness of the adjustable suspension air spring so as to adjust the spring rate. Although the adjustable, dual-chamber suspension air spring is generally described herein as using air for the operating gas, it will be appreciated by a person skilled in the art that the present disclosure is not so limited and that other gases or fluids may be utilized as the operating gas or fluid to independently change the pressure in the chambers of the adjustable suspension spring. For example, compressed CO₂ or other suitable compressed gases, or as another example, hydraulic fluids used in conjunction with air or another compressible gas or compressible fluid to change the pressure of the compressible gas or fluid, may also be employed.

In another aspect of the present disclosure, a method for automating the control of the active suspension system is provided. By utilizing various different sensors to determine the operating condition of the vehicle and/or the condition of the surrounding terrain at a given point in time, for example sensors monitoring the position of the suspension system or wheel relative to the frame or chassis, and pressure sensors in each of the upper and lower chambers of each air spring, an electronic controller and cooperating processor controls the valving of each inlet/outlet or port of each chamber of each air spring so as to independently adjust the pressure in the upper and lower chambers of each cylinder suitable for a given terrain condition detected by the sensors, as determined by the processor.

In another aspect of the present disclosure, an active suspension control system for individually controlling a suspension assembly of each corresponding wheel assembly of a plurality of wheels of a vehicle in response to driving conditions, the control system comprising a plurality of suspension assemblies corresponding to the plurality of wheels, each suspension assembly of the plurality of suspension assemblies including an adjustable suspension spring, each adjustable suspension spring of the plurality of suspension assemblies including a hollow, fluidically sealed cylinder and a piston having a shaft and a head, the piston cooperating within the cylinder, the cylinder having an upper chamber divided from a lower chamber by the piston head, the lower chamber being adjacent to the piston shaft coupled to the corresponding wheel assembly, each chamber of the upper and lower chambers of the suspension spring having a port fluidly coupled to a fluid line and a valve of a valve assembly, wherein a first end of the fluid line is fluidly coupled to the port and a second end of the fluid line is coupled to the valve, the valve assembly operatively coupled to an electronic controller to control each valve of the valve assembly and a fluid source fluidly coupled to each valve of the valve assembly, wherein the extension or retraction of each adjustable suspension spring is controlled by selectively introducing and/or removing a volume of a fluid from the upper and/or lower chambers of said adjustable suspension spring through the fluid line.

In still another aspect of the present disclosure, a method of controlling an active suspension system of a vehicle having a plurality of wheels, the active suspension system including a suspension assembly corresponding to each wheel assembly of each wheel of the plurality of wheels, the method steps comprising: providing a suspension assembly corresponding to each wheel assembly, each suspension assembly including an adjustable suspension spring having a hollow, fluidically sealed cylinder and a piston having a shaft and a head, the piston cooperating within the cylinder, the cylinder having an upper chamber divided from a lower chamber by a piston head, the lower chamber being adjacent to the piston shaft coupled to the corresponding wheel assembly, each chamber of the upper and lower chambers of the suspension spring having a port selectively fluidly coupled to a fluid supply through a fluid line and a valve of a valve assembly, the valve assembly operatively coupled to an electronic controller to control each valve of the valve assembly, receiving one or more control inputs into the electronic controller, generating one or more control outputs, each control output of the one or more control outputs including an instruction to one or more valves of the valve assembly to open or close so as to add a fluid of the fluid supply to or remove the fluid from the upper or lower chamber of one or more adjustable suspension springs, and applying the one or more control outputs by the electronic controller to the one or more valves of the valve assembly.

### BRIEF DESCRIPTION OF THE DRAWINGS

FIG. 1 is a schematic illustrating an embodiment of the suspension control system;

FIG. 2 is a schematic illustrating an alternative embodiment of the suspension control system;

FIG. 3 is a side perspective view of an embodiment of the suspension assembly;

FIG. 4 is a perspective view of an embodiment of the present disclosure traversing across a slope;

FIG. 5A is a front perspective view of an embodiment of the present disclosure;

FIG. 5B is a side perspective view of the embodiment illustrated in FIG. 5A;

FIG. 6 is a rear perspective view of an embodiment of the present disclosure;

FIG. 7 is a state diagram illustrating an interrelationship between different control states of an embodiment of the present disclosure;

FIG. 8 is a logic flow diagram illustrating one embodiment of a control method for controlling the suspension system so as to level a vehicle;

FIG. 9 is a logic flow diagram illustrating one embodiment of a control method for controlling the suspension system so as to balance the pressure of each adjustable suspension gas spring relative to the other suspension gas springs of the vehicle once the vehicle is level;

FIG. 10 is a logic flow diagram illustrating one embodiment of a control method for controlling the suspension system so as to stabilize the vehicle as it travels in any direction along a slope;

FIG. 11 is a logic flow diagram illustrating one embodiment of a control method for controlling the suspension system so as to lean the vehicle into a curve as the vehicle steers through a corner; and

FIG. 12 is a logic flow diagram illustrating one embodiment of a control method for controlling the suspension system so as to temporarily equalize the pressure in the upper chambers of a pair of suspension gas springs as one wheel of the vehicle travels over an obstacle.

### DETAILED DESCRIPTION

### Adjustable Suspension Gas Springs

In accordance with the present disclosure, the active suspension system 10 comprises a valve assembly 12, such as a valve block, operatively connected to a fluid source 14 and an electronic controller 16. The valve assembly 12 may comprise a plurality of bidirectional valves, wherein each bidirectional valve is connected to a fluid line leading to either the upper chamber or the lower chamber of an adjustable suspension spring. As used herein, a fluid line and fluid source refer, in describing an embodiment of the present disclosure, to an air line and an air source, respectively; however, it will be appreciated by a person skilled in the art that other compressible gases or other fluids may also be utilized and fall within the scope of the present disclosure.

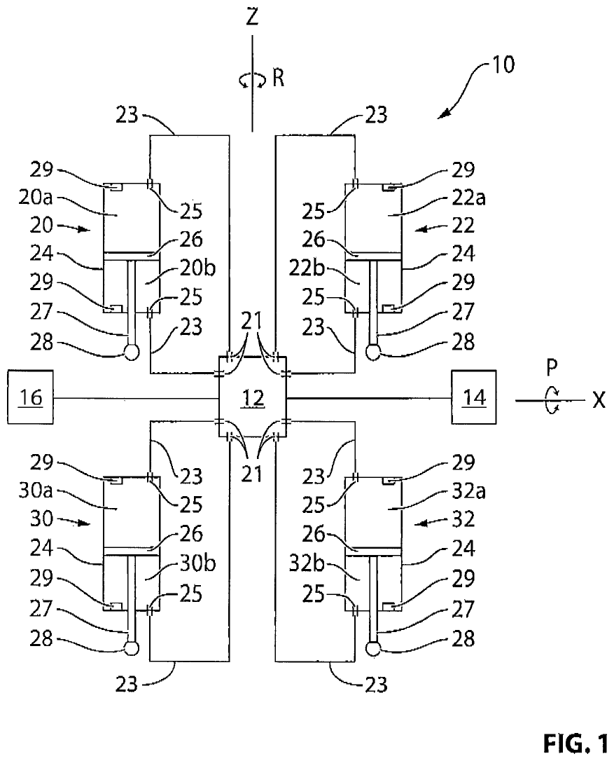

As shown in FIG. 1, adjustable suspension gas springs 20 and 22 are operatively coupled to the front left and right wheel assemblies respectively, and adjustable suspension gas springs 30 and 32 are operatively coupled to the rear left and right wheel assemblies respectively of a four-wheeled off-road vehicle 1. In an embodiment of the present disclosure, for example, the adjustable suspension springs 20, 22, 30, and 32, may each comprise of a cylinder 24, a piston 26 and a piston shaft 27 having coupling 28 for coupling to the respective wheel assembly, described below.

Each adjustable suspension spring is divided into two chambers. For example, the front left adjustable suspension spring 20 is divided into an upper chamber 20a and a lower chamber 20b, whereby the upper and lower chambers 20a, 20b, are separated by the piston 26. Piston shaft 27 extends through the lower chamber 20b and is adjacent wheel assembly coupling 28. As used herein and in the accompanying drawings, the terms “upper chamber” and “A chamber” are used interchangeably, and the terms “lower chamber” and “B chamber” are used interchangeably. Thus, when a wheel assembly coupled to an adjustable suspension spring encounters a rock, log or other obstacle on the terrain over which the vehicle is travelling, the approximately vertical force of the force vector experienced by the wheel is transmitted through the coupling 28 and shaft 27 to slide the piston 26, thereby increasing the pressure in upper or A chamber (20a, for example) and decreasing the pressure in the lower or B chamber (20b, for example), presuming that the operating fluids in the upper and lower chambers are compressible.

Similarly, adjustable suspension spring 22 is divided into upper and lower chambers 22a, 22b; adjustable suspension spring 30 is divided into upper and lower chambers 30a, 30b; and adjustable suspension spring 32 is divided into upper and lower chambers 32a, 32b. Each of the upper and lower chambers 20a, 20b of the adjustable suspension spring 20 are provided with a port 25 fluidly coupled to a fluid line 23, and each fluid line 23 is attached at the other end to a valve 21 mounted to the valve assembly 12. Similarly, the upper and lower chambers of each of the other adjustable suspension springs 22, 30, 32, each are provided with an port 25 coupled to a fluid line 23, whereby the opposite end of the fluid line 23 is coupled to a valve 21 mounted to the valve assembly 12. Furthermore, each of the upper and lower chambers of each of the adjustable suspension springs 20, 22, 30, 32, are provided with a pressure sensor 29 for monitoring the pressure of each chamber. The pressure sensors 29 are in electronic communication with electronic controller 16; however, wires between the sensors 29 and the electronic controller 16 are not illustrated in the Figures for the sake of clarity. In other embodiments of the present disclosure, the electronic communication between the electronic controller 16 and the sensors may also be accomplished wirelessly.

### Control System

Thus, it may be appreciated that in the embodiment of the active suspension system 10 illustrated in FIGS. 1 through 6, each of the wheels 2 of a vehicle 1, in the example illustrated a vehicle having four wheels, the suspension of each wheel is independently adjustable by changing the pressure in the upper and/or lower chambers of each of the adjustable suspension springs 20, 22, 30, and 32 so as to adapt suspension of each individual wheel for a particular terrain or driving conditions, as will be further described below. Each of the upper and lower chambers of each adjustable suspension spring is provided with a pressure sensor to monitor the pressure in each of the upper and lower chambers of the suspension springs 20, 22, 30 and 32, and that pressure data is communicated to the electronic controller 16, which data is then used as inputs in various control states and control methods that will be further described below.

It will be appreciated by a person skilled in the art that the spring rate and other characteristics, such as actively and positively extending or retracting the positioning of the rods of the adjustable suspension springs 20, 22, 30, and 32, may thus be adjusted by actively adding air to or by actively removing air from the upper and/or lower chambers through the fluid lines 23, and controlled by the valves 21 mounted to the valve block or valve assembly 12. The fluid source 14 provides the working compressible fluid being used to adjust pressures in each of the upper and lower chambers of the adjustable suspension springs. So for example, in a pneumatic suspension system, each of the adjustable springs may be air springs and the working fluid being added to or removed from adjustable suspension spring upper and lower chambers is compressed air obtained from fluid source 14, which may for example be a conventional air compressor. However, it will be appreciated by a person skilled in the art that other adjustable suspension springs systems utilizing different fluids to control the pressure in the upper and lower chambers of the adjustable suspension springs may also be utilized and are intended to included within the scope of the present disclosure. For example, the fluid provided by the fluid source 14 may include compressed gases other than air, such as for example carbon dioxide or other suitable inert compressible gases known to a person skilled in the art, or may include for example hydraulically driven systems wherein the fluid source 14 provides hydraulic fluid or other non-compressible fluid so as to compress or de-compress the air or other compressible gas within that particular chamber by adding or removing fluid to the chamber.

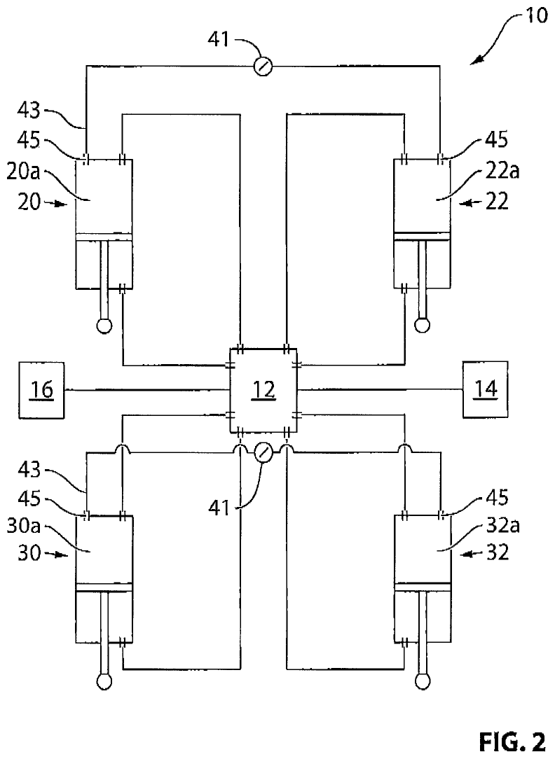

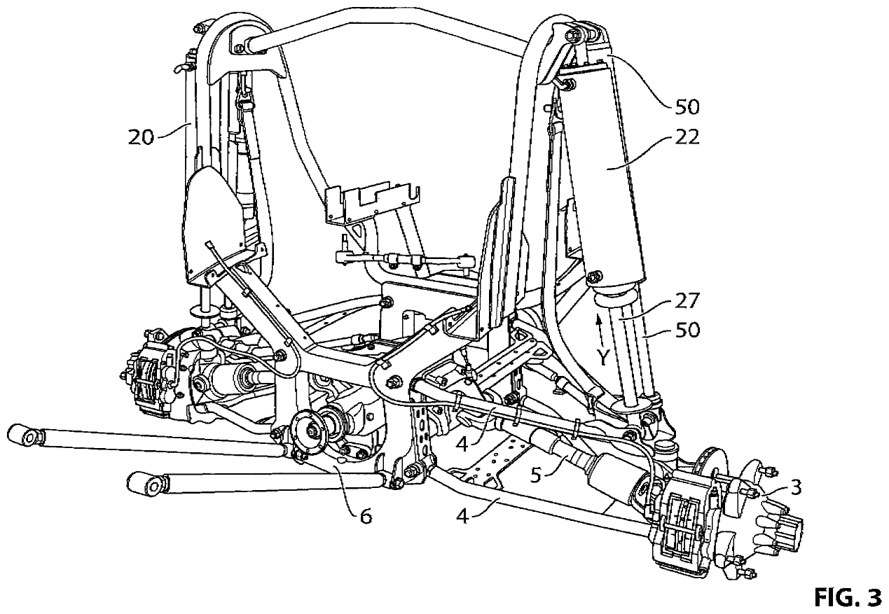

In an alternative embodiment of the present disclosure, as illustrated in FIG. 2, so as to facilitate movement of air between the upper chambers of adjacent adjustable suspension springs to equalize the pressure in those upper chambers (as will be further described below), an additional crossover fluid line 43 having a bi-directional valve 41 connected in series to the fluid line 43 may be coupled at one end to an additional port 45 leading to the upper chamber of an adjustable suspension spring, and the other end of the crossover fluid line 43 may be coupled to an additional port 45 leading to an upper chamber of an adjacent adjustable suspension spring. For example, as illustrated in FIG. 2, the upper chambers 20a, 22a of the front left and right suspension springs 20, 22 may be selectively in fluid communication through the corresponding fluid line 43 by opening the valve 41; similarly, upper chambers 30a, 32a of the rear left and right suspension springs 30, 32 may be selectively in fluid communication through corresponding fluid line 43 by opening the corresponding valve 41. In alternative embodiments of the present disclosure, without intending to be limiting, the suspension system 10 may include shocks 50, as may be seen for example in FIG. 3.

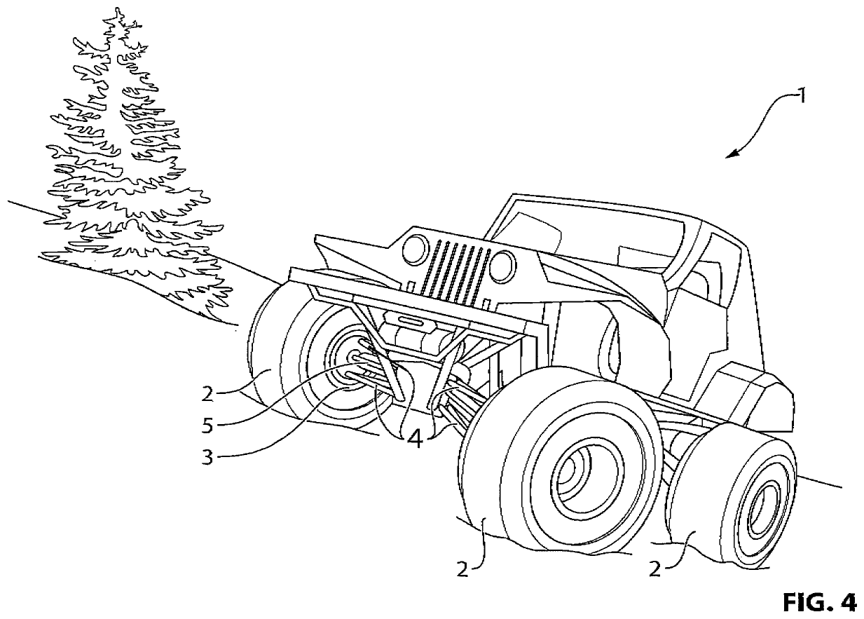

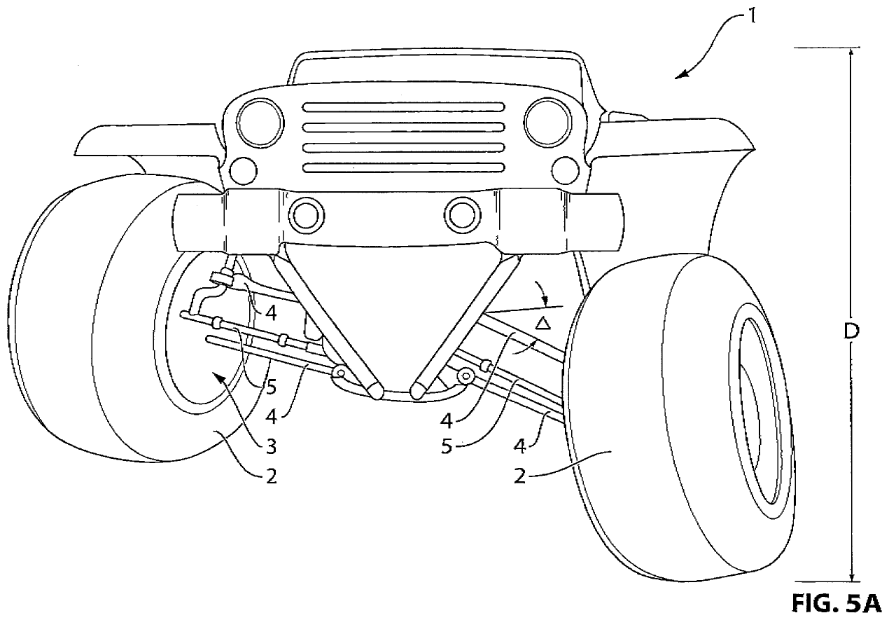

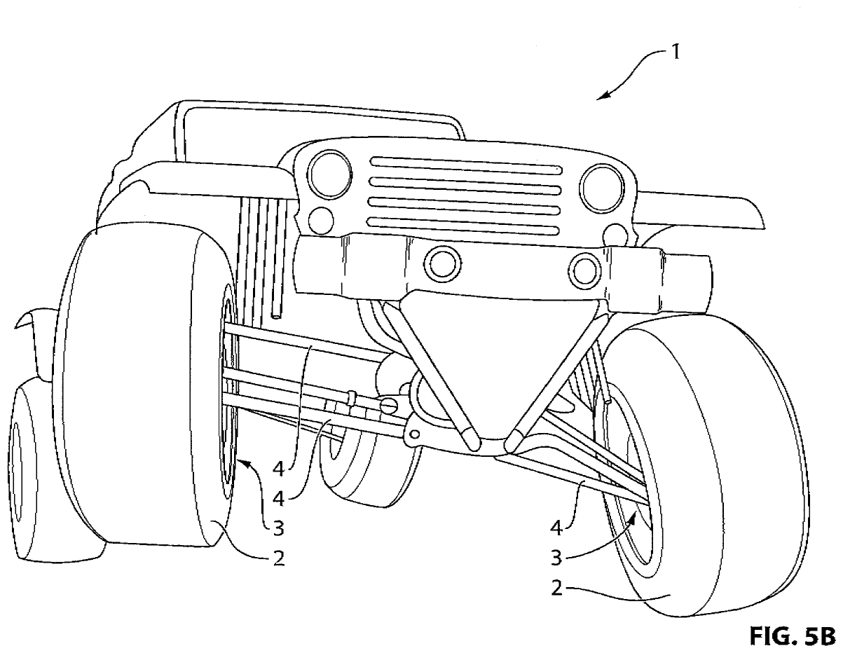

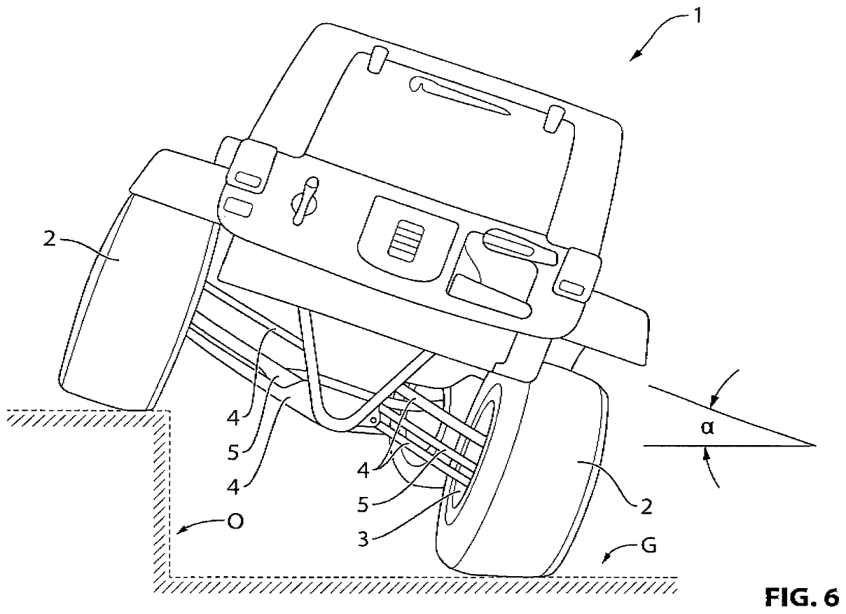

Now referring to FIGS. 4 through 6, the suspension system 10 may be deployed in various types of off-road or no-road vehicles 1 such as for example, a sports utility vehicle like the one illustrated by way of example in FIG. 4, or a truck, or any other type of vehicle suitable for traversing over rough terrain. Preferably, large, for example 46 inch, tires 2 may be utilized. Other sized tires will also work. Advantageously, the suspension system 10 enables tire travel over a distance D, such as seen in FIG. 5A (although not drawn to scale), of substantially up to 30 inches. Each suspension spring 20, 22, 30, 32 may be constructed of a cylinder 24 having a height of substantially twelve to fourteen inches and approximately four inches diameter; however, it will be appreciated that these dimensions are provided by way of example only and are not intended to be limiting. The wheels or tires 2 may be mounted to the differential housing 6 by means of, for example, a pair of A arms 4, 4. A drive shaft 5 may be mounted between the differential housing 6 and the wheel hub 3 of tire 2, and located between the pair of A arms 4, 4. As may be seen for example in FIGS. 5A and 6, the relatively large vertical travel distance D, combined with each wheel 2 being independently articulable according to the suspension pressure-balancing control system also described below, enables a particular wheel 2 to cross over large obstacles 7 while maintaining traction.

### Control System Methods and Functions

Below, the Applicant describes several different control states and control functions or methods that may be implemented using the active suspension system 10 disclosed herein. As will be appreciated by a person skilled in the art, in some cases, some of the control functions described below may be designed to work in parallel with other control functions, while in other cases, a particular control function may be intended to work alone or in combination with only certain other control functions. For each of the control functions described below, the electronic controller 16 automatically implements the particular control function for a particular mode or state of operation, depending on inputs received from various sensors deployed throughout the vehicle 1 and/or instructions input to the electronic controller 16 by the user of the system.

### Levelling Function

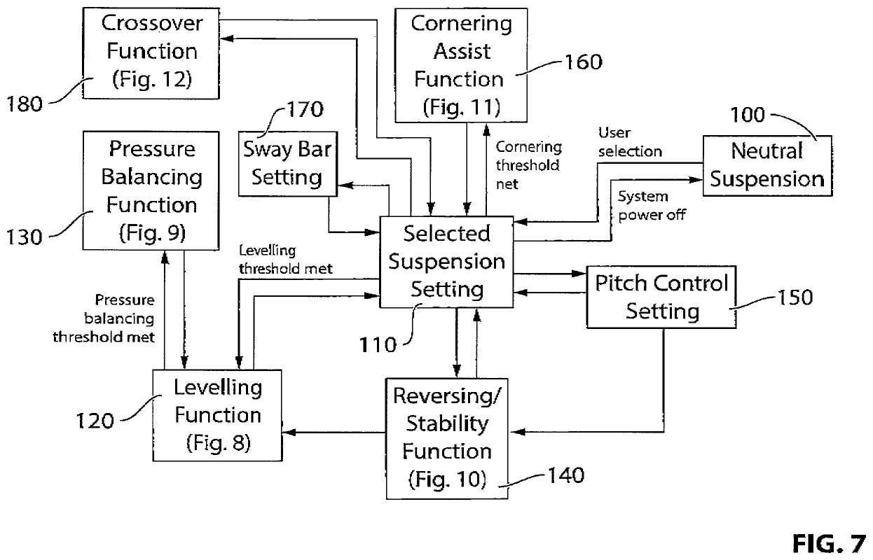

Referring now to FIG. 7, the active suspension system 10 may include controllers such as digital processors, programmable logic controllers and the like, collectively referred to herein as electronic controllers 16, which may be programmed to perform a number of control functions such as those set out below. It will be appreciated by a person skilled in the art that the controllers 16 utilized to electronically automate control of the active suspension system 10 may include various different types of hardware and software or code, such as for example a control software program stored in and executed by one or more microprocessors, but that the present disclosure is not limited to such a combination of software and hardware and that other combinations come within the scope of the present disclosure.

Without intending to be limiting, the relationship between the various control functions which control operation of the active suspension system 10 may be described based on the various states of the suspension system 10 and how those states may relate to each other. Without intending to be limiting, the applicant refers to the state diagram of FIG. 7, illustrating just one example of how the various different control functions may relate to various states of the suspension system 10 depending on external factors or inputs, such as changes in the driving conditions and driving terrain as detected by various sensors deployed throughout the vehicle 1, and/or internal factors or inputs, such as the selection of a particular control mode, state or function as selected by the user.

With reference to FIG. 7, for example, a default neutral suspension state 100 may include a resting position of each adjustable suspension spring 20, 22, 30 and 32 for when the vehicle 1 is not in use. Upon starting up of vehicle 1, a control panel (not shown) in the vehicle 1 may display a series of pre-set suspension settings, and by selecting one of the pre-set suspension settings, the system 10 may change to the selected suspension setting state 110, where again each of the adjustable suspension springs 20, 22, 30 and 32 are configured for a particular use as selected by the driver or user of the system. For example, without intending to be limiting, for a two wheel drive (2WD) vehicle, such pre-set suspension settings may include a normal highway mode wherein the suspension is adjusted to a range of approximately 25-30% of the total possible ride height of which the suspension system is capable, as well as a high speed mode wherein the suspension is adjusted to a range of approximately 10-20% of the total possible ride height.

As another example, again without intending to be limiting, for a four wheel drive (4WD) vehicle, the pre-set suspension settings available when the system 10 is in the selected suspension setting state 110 may include separate settings for low range and high range. A pre-set suspension setting for high range 4WD may increase the ride height to the range of 45-50% of the total possible ride height, and for low range 4WD at medium speeds, the ride height may be increased to the range of 65-70% (when medium clearance conditions are presented), and yet another pre-set suspension setting for high range 4WD adjusting the ride height to the range of 85-90% (for low speed conditions when high clearance conditions, for example large obstacles such as fallen logs and boulders, are presented). Still another pre-set suspension setting for low range 4WD vehicle mode may be available for driving conditions that include for example crossing over ditches or drop offs at a high speed, such as may be required in recreational off road vehicle competitions, in which each of the adjustable suspension springs are set at approximately 90% of the total possible ride height, and in addition, the rear lower or B chambers 30b, 32b are each pressurized so as to pull down the ride height of the adjustable rear suspension springs 30, 32 to approximately 80% of the total available ride height. The phrase “pull down the ride height” is defined by reducing the angle A between the A-arm and the plane of the bumper (as seen in FIG. 5A) by the same amount on both sides of the rear of the vehicle 1, accomplished by reducing the pressure in the B chamber of the corresponding cylinder 24 in direction Y (shown in FIG. 3). All of the pre-set suspension settings described above, or any combination of them, along with other pre-set suspension settings not mentioned herein, may be made available to the user or driver of the system 10 when the system is in the neutral suspension state 100, and selection of any of these pre-set suspension settings causes the system to shift to the selected suspension state 110.

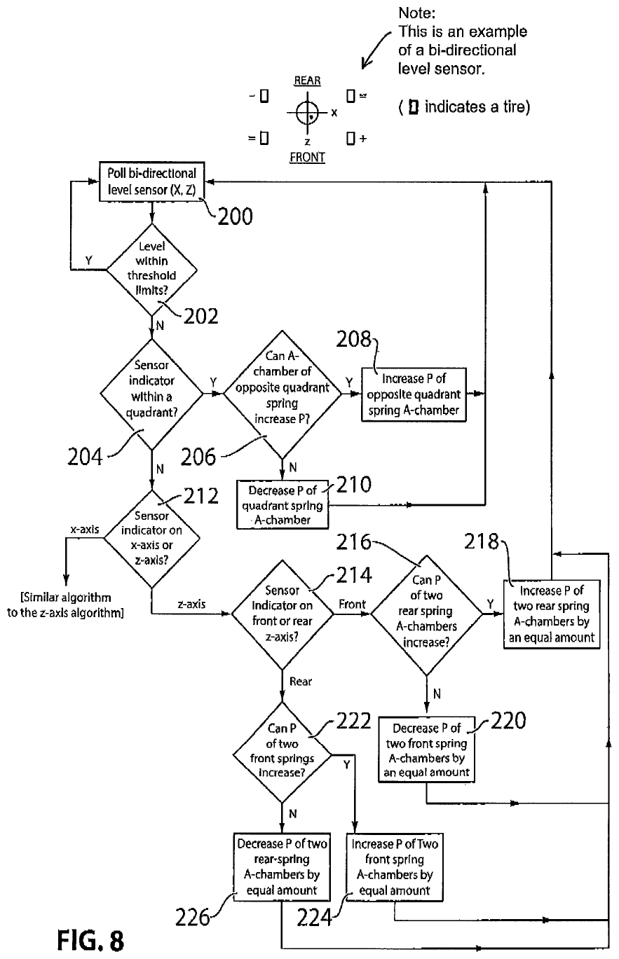

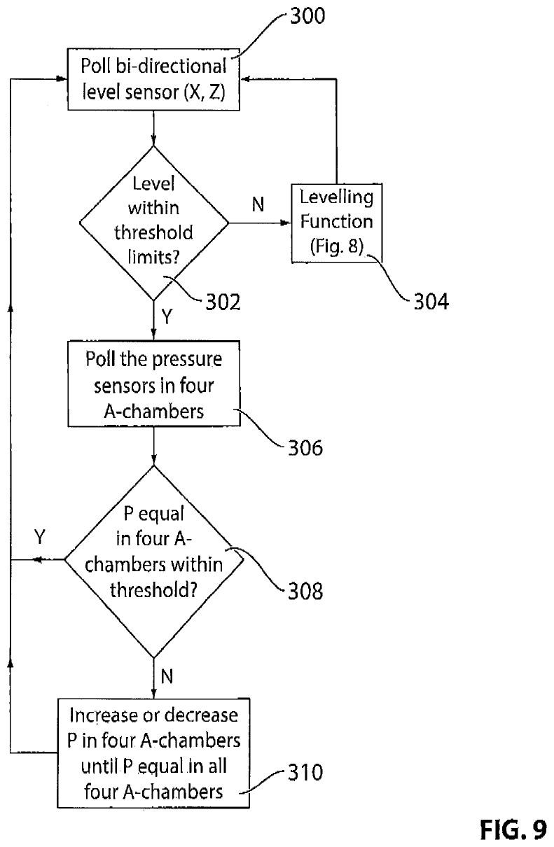

Once the suspension system 10 is in the selected suspension setting state 110, the control may return to the neutral suspension state 100, for example when the user powers the control system on. Otherwise, once the suspension system 10 is in selected suspension state 110, the system may move to any given number of states either as a result of changes in terrain or driving conditions that are automatically detected by sensors cooperating with the system 10, or otherwise as a result of instructions input into the system 10 by the user. Each of the states may represent a different control functionality carried out by the system. For example, if the vehicle 1 begins to travel over very uneven terrain, causing the vehicle 1 to become very unlevel, sensors positioned throughout the vehicle indicating that the vehicle 1 is oriented in such a manner so as to cross a given threshold angle α (illustrated in FIG. 6) relative to the ground G, the system may move into a leveling state 120, in which state the leveling control function may be carried out, an example of an algorithm for which is provided in FIG. 8. Once the system 10 has carried out the levelling function, such as that described in FIG. 8, the system 10 may either return to the selected suspension state 110 once the vehicle 1 is within the pre-determined leveling parameters of the control system 10, or as another example, if the system 10 detects that there is a pressure imbalance in one of the cylinders associated with each of the four wheels 2 of the vehicle 1, that falls outside of a pre-determined pressure balancing threshold, the system 10 may then shift into the pressure balancing state 130 under which the system 10 carries out an algorithm to achieve better balance of the pressure amongst the four tires, an example algorithm for which is illustrated in FIG. 9. The leveling and pressure balancing states 120, 130 may be particularly useful for example when the vehicle 1 is traversing over large obstacles O (illustrated by way of example in FIG. 6) or other rough terrain.

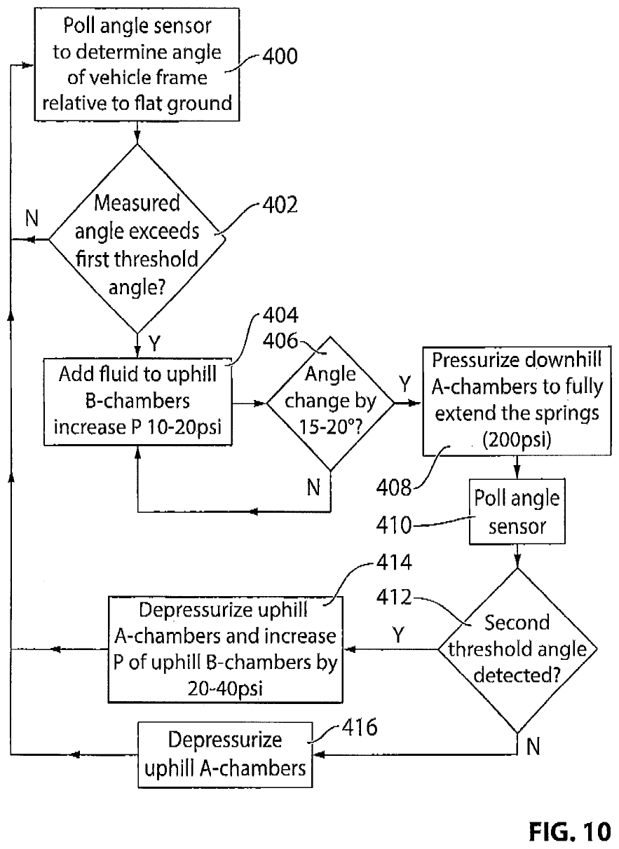

Other examples of various different states that the suspension system 10 may enter into include a reversing and stability state 140, in which state the suspension system 10 would adjust the suspension in accordance with an algorithm so as to increase the stability of the vehicle 1; an example of a reversing and stability control algorithm is provided in FIG. 10. The system 10 may move from the selected suspension state 110 to the reversing and stability state 140, for example, when the system 10 detects through accelerometers, potentiometers, or other appropriate sensors, that the vehicle 1 is traversing on a slope such as seen by way of example in FIG. 4 which depicts vehicle 1 traversing up a steeply inclined, snow-covered glade. While in state 140, once the reversing and stability function algorithms are applied, should the vehicle sensors detect that the vehicle orientation has reached a threshold whereby the leveling function should be utilized so as to level vehicle 1, the control system may shift from the reversing and stability state 140 to the leveling state 120. In other driving conditions, once the vehicle is finished traversing the slope, the system 10 may revert from the reversing and stability state 140 to the selected suspension setting state 110.

Another control function which may assist with preventing a vehicle 1 from flipping end-over-end when travelling at a high velocity and encountering a ditch or drop off; for example, the pitch control state 150, wherein the rear suspension is pulled down relative to the front suspension (ie: angle A reduced on both sides), as will be described further below. The pitch control state 150 may be a user selected suspension setting. In some embodiments of the present disclosure, such as is shown in FIG. 7, when the vehicle 1 is in the pitch control state 150, automatic detection of the vehicle 1 traversing a slope may cause the suspension system 10 to move to the reversing and stability state 140, in which state the reversing and stability control function algorithms would be carried out until the slope has been traversed, at which point the system 10 reverts to selected suspension state 110, or until the system 10 detects that the vehicle has crossed the leveling function threshold (for example, not intending to be limiting, within plus or minus 5° of level), in which case the system 10 may then move to levelling state 120. Although FIG. 7 shows that there are certain interrelationships between the different control states, it will be appreciated by a person skilled in the art that other interrelationships between the various states may also exist and are intended to be included within the scope of the present disclosure.

Other control states that may form part of the suspension system 10 includes a cornering assist state 160, which may be triggered for example upon automated detection of the steering column having rotated beyond a predetermined threshold angle, or any other suitable means for detecting when a vehicle 1 is entering into a turn such that the cornering assist state 160 should be engaged. The control system may also include sway bar state 170, which, as will be described below, involves adjustments to the suspension springs 20, 22, 30, and 32 so as to restrict body roll and provide similar functionality to having a mechanical sway bar, which sway bar state 170 may advantageously be turned selectively on and off. Crossover state 180 may allow crossflow of the fluid or gas between adjacent upper chambers so as to balance the pressure between those two upper chambers, for example between chambers 20a and 22a through crossover line 43 by opening crossover valve 41.

### Levelling Control Function

An example of an algorithm that may be utilized to achieve leveling of vehicle 1 in the leveling state 120 will now be described with reference to FIG. 8. In step 200, the detection of the orientation of the vehicle 1 relative to the ground may occur for example by polling a level sensor which indicates the orientation of the particular portion of vehicle 1, such as the frame or chassis of the vehicle, relative to the ground. Referred to herein generally as “level sensors,” such sensors may include for example accelerometers, inclinometers, potentiometers and other types of sensors which are capable of monitoring and detecting, in some embodiments of the present disclosure, the pitch and/or roll of the vehicle 1 relative to the ground. The level sensors would preferably be in communication with the electronic controller 16 so as to utilize the measurements of the operating or driving status of the vehicle 1 as inputs for controlling the active suspension system 10. In the example levelling algorithm illustrated in FIG. 8, a bi-directional inclinometer is utilized; however, it will be appreciated by a person skilled in the art that other levelling algorithms utilizing inputs provided by other types of level sensors are intended to be included within the scope of the present disclosure.

Upon polling a bi-directional level sensor in step 200, step 202 would query whether the pitch and roll of the vehicle 1, as measured by the level sensor, falls within certain threshold levelling limits of the system 10. In the case that the vehicle 1 is level within the threshold limit, the algorithm may return to step 200 of continuing to poll the bi-directional level sensors, for example at a frequency of once per second or any other polling rate that would be suitable for a particular application. In the event that the level, or in other words the pitch and roll of the vehicle 1, fall outside of the threshold limit, the algorithm would proceed to step 204 at which step the suspension system 10 determines whether the level sensor indicator has detected an imbalance in either the pitch or roll the vehicle, or both. For example, if, such as seen diagrammatically in FIG. 1, the roll R of the vehicle is about a z-axis and the pitch P of the vehicle is about an x-axis, output from a level sensor would allow a levelling imbalance in the x-axis, the z-axis or both to be determined by an electronic controller 16. As an example, if the level sensor indicator of a bi-directional inclinometer is located in one of the four quadrants defined by the x and z axes, this indicates that both the pitch and the roll of vehicle 1 may need to be corrected in order to bring the level of the vehicle within the threshold limits.

By way of example, without intending to be limiting, if from the driver's perspective the sensor indicator is in the front left quadrant of the inclinometer, this means the rear right wheel 2 of vehicle 1 is too low relative to the other three wheels, and therefore the suspension spring 32 corresponding to the rear right wheel requires pressure to be added to the A chamber 32a so as to raise the right rear wheel relative to the other wheels. If it is not possible to add pressure to the A chamber 32a, then it may be possible to reduce the pressure in the A chamber 20a of the suspension spring 20 corresponding to the left front wheel of the vehicle to thereby lower the left front wheel relative to the other three wheels. This type of correction is what is meant in the description of the algorithm steps of FIG. 8 below, when reference is made to “opposite quadrant spring”, it is the suspension spring located in the corner of the vehicle that is opposite the corresponding quadrant of the inclinometer where the sensor indicator is located.

Continuing the description of the levelling algorithm of FIG. 8, at step 204 if the sensor indicator is in a particular quadrant, then the algorithm may proceed to step 206 in which it is determined whether the A chamber of the suspension spring corresponding to the wheel that is opposite the inclinometer quadrant of where the sensor's indicator is located, is capable of an increase in pressure. If the said upper or A chamber is available to receive an increase in air pressure, then the system may proceed in step 208 to increase the pressure, at which point the algorithm returns to polling the level sensor at step 200. In the event that the A chamber of the adjustable suspension spring opposite the sensor indicator's quadrant cannot be increased, as determined at step 206, then the same leveling may be achieved by decreasing the pressure of the adjustable suspension spring's A chamber corresponding to the wheel that is adjacent the quadrant in which the sensor indicator is located, at step 210. It will be appreciated by persons skilled in the art that FIG. 8 does not include all of the operational details of the programming of electronic controller 16 and carrying out the algorithm steps described in FIG. 8; for example, a Proportional-Integral-Derivative (PID) loop or similar logic control feedback may be utilized, for example at steps 208 and 210, so as to control the timing, rate and magnitude of pressure adjustments made over time to a given suspension spring.

Returning to step 204 in the algorithm described in FIG. 8, if the sensor indicator is not within a quadrant but rather located along the x-axis or z-axis, the algorithm may proceed to step 212, at which point the algorithm determines whether the sensor indicator is located along the x-axis or the z-axis, thereby indicating whether there is an imbalance in either the roll or the pitch of the vehicle 1. By way of example only, but not intended to be limiting, if the sensor indicator was along the z-axis that would indicate an imbalance in the pitch of the vehicle 1. On the other hand, if the sensor indicator is located along the x-axis, that may indicate that the roll of the vehicle 1 is imbalanced, and the further algorithm steps (not shown in FIG. 8) may be utilized so as to correct the roll of the vehicle 1, similar to the algorithm steps for correcting the pitch of the vehicle as further described below.

In the event that the sensor indicator is located on the z-axis on indicating an imbalance in the pitch of the vehicle, at step 214 of the algorithm it may be determined whether the sensor indicator is located on the front or rear portion of the z-axis. For example, should be sensor indicator be on the front portion of the z-axis, then the algorithm in step 216 may determine whether the pressure of the two rear suspension spring A chambers 30a, 32a may be increased so as to raise the rear axle of the vehicle 1 relative to the front axle. If such a pressure increase in the rear upper or A chambers of the adjustable suspension springs is possible, then in step 218 the system 10 may cause the pressure of the upper chambers 30a, 32a, to increase and thereby raise the rear axle of the vehicle, after which point the algorithm would again return to step 200. However, in the event that the pressure of the two rear spring A chambers 30a, 32a are not capable of being increased, for example because the two rear A chambers 30a, 32a are already pressurized by the maximum amount, then the algorithm would move to step 220 to decrease the pressure in the two front spring suspension A chambers 20a, 22a, so as to lower the front axle of the vehicle relative to the rear axle, after which the algorithm would return step 200.

Similarly, at step 222, should the sensor indicator be located on the rear portion of the z-axis, the algorithm would determine whether the pressure of the A chambers 20a, 22a of the two front suspension springs 20, 22, may be increased, and if so, the pressure of the A chambers 20a, 22a are accordingly increased at step 224. On the other hand, should the upper or A chambers 20a, 22a not be capable of further pressure increases, in step 226 the pressure of the upper or A chambers of the two rear suspension springs 30a, 32a would be decreased, thereby lowering the rear axle of the vehicle 1 relative to the front axle. Again, after either step 224 or step 226 had taken place, the algorithm would return to step 200 to poll the level sensors to determine the new orientation of the vehicle after the suspension adjustments have been made. The algorithm described in FIG. 8 may continue for as long as suspension system 10 is in the leveling function state, until such time as the system moves a different control state, such as upon detection of changed driving or operating conditions which indicate that leveling state 120 no longer required.

It will be appreciated by a person skilled in the art that the leveling function algorithm presented in FIG. 8 is not intended to be limiting and that other control algorithms, utilizing different steps in different combinations, may achieve the same levelling function within the active suspension system 10 and are intended to be included within the scope of the present disclosure. For example, a simplified system may only utilize a control function for leveling either the pitch or the roll of the vehicle, but not both at the same time. Furthermore there may be one or more level sensors that are utilized throughout the vehicle 1 and the level sensors may or may not be bi-directional in their determination of the orientation of the vehicle 1. And as previously mentioned, the steps in the levelling algorithm illustrated in FIG. 8 where the pressure of the A chambers of the suspension springs are adjusted, may include further algorithms or hardware control mechanisms, such as for example PID loops, which would control the rates and amounts of pressure adjustments made in those algorithm steps so as to properly cause the suspension spring adjustments to occur as smoothly as possible, for example in steps 208, 210, 218, 220,1224 and 226 of the sample levelling algorithm shown in FIG. 8.

In some embodiments of the present disclosure, as described with reference to FIG. 7, in addition to the leveling state 120 there may also be a pressure balancing state 130 in which the suspension system 10 utilizes an algorithm that attempts to balance the pressure being experienced by each of the four wheels 2 of vehicle 1 within certain threshold limits. Surprisingly, the applicant has found that balancing the pressure experienced by each of the tires (for example, without intending to be limiting, on a four-wheeled vehicle) plays an important role in maintaining the stability of the vehicle 1 as it traverses over slopes or very rough terrain. In some cases, the applicant has discovered that balancing the pressure experienced by each of the vehicle's tires may be equally important to stabilizing the vehicle while traversing over rough terrain as is levelling the vehicle, so as to for example avoid the vehicle pitching end over end or rolling over on one side.

### Pressure Balancing Function

As shown for example in FIG. 7, in embodiments where the pressure balancing state 130 may be used in conjunction with leveling state 120 so as to improve the stability of vehicle 1, the leveling state 120 may transition to the pressure balancing state 130 when the vehicle 1 is brought within the level threshold limits, for example as determined in step 202 of the leveling algorithm (FIG. 8), at which point the pressure sensors associated with each of the four cylinders 22 corresponding to each of the four wheels may be polled so as to determine whether there is a pressure imbalance within a certain threshold, thereby causing the control system to transition from state 120 to state 130. An example of a pressure balancing algorithm, not intended to be limiting, will now be described with reference to FIG. 9.

In the pressure balancing state 130, the algorithm may commence with step 306 wherein the pressure sensors 29 in each of the upper chambers 20a, 22a, 30a, and 32a may be queried so as to determine whether the pressure balance amongst the four tires is substantially equal within a pressure balance threshold, as determined in step 308. The object in state 130 is to adjust the pressure in the A and B chambers of each cylinder 22 so that each tire exerts the same downward pressure on the ground G or obstacle O. Where the downward pressure exerted by each of the four tires falls within a given threshold, the algorithm may return to polling the level sensor at step 300 so as to determine whether leveling adjustments are required, as more fully described above with reference to FIG. 8. However, where at step 308 it is determined that the pressure of one or more upper or A chambers is much lower or much higher than the other upper or A chambers, thereby indicating that the pressure balancing threshold has been crossed, then the algorithm at step 310 may engage in increasing or decreasing the pressure in one or more of the upper or A chambers of the springs as may be required, until the pressure in each of the upper chambers of the suspension springs become substantially equal within the threshold limits. It will be appreciated by a person ordinarily skilled in the art that step 310 may include further sub-algorithms or other types of automation control feedback devices, such as PID loops, which may incrementally increase or decrease of the pressure in one or more of the upper chambers until the pressure balance threshold has been met, without undue over-shoot or porpoising so that the equilibrium solution is rapidly obtained. It will also be appreciated by a person skilled in the art that steps 300, 302, and 304, shown in FIG. 9, may not part of pressure balancing state 130 shown in FIG. 7, for example, where the pressure balancing state 130 is only active once a certain level threshold has been met. It will also be appreciated by a person skilled in the art that the states shown in FIG. 7 and the algorithms shown in FIGS. 8 and 9 are not intended to be limiting in that there may be other interrelationships between, for example, the leveling state 120 and the pressure balancing state 130 other than as presently illustrated in FIG. 7, and that such variations are intended to be included in the scope of this disclosure. Applicant has determined that the key is to achieve some combination of leveling the vehicle frame relative to the ground and balancing the pressure in the upper chambers of the suspension springs within certain threshold limits, recognizing that there will be a trade-off between leveling and pressure balancing, so as to achieve optimal stabilization of the vehicle 1, particularly in situations where the vehicle is traversing steep slopes and or travelling over large obstacles or otherwise travelling across difficult terrain.

### Reversing/Stability Function

The reversing and stability state 140, shown in FIG. 7, is an example of a state that may useful when the vehicle 1 encounters a particularly steep slope, and an example of a reversing and stability control algorithm will now be described with reference to FIG. 10. The reversing and stability state 140 would be particularly useful for extreme slope condition for slopes of substantially 40° or greater, although it will be appreciated by persons in the art that the same functionality may also be useful in less extreme slope conditions, for example slopes in the range of 15° to 20° (angle α, approximately equal to 15° to 20°) which may be typically encountered by vehicle travelling over rough terrain to reach a remote work location. The functionality of state 140 may also be useful when extreme conditions are encountered in traversing particularly rough terrain, for example when a tire on the bottom side of a slope is dug into soft ground and the upper side tires are freewheeling without contacting the ground (presuming for example the vehicle does not have a locked differential).

As shown in FIG. 10, step 400 of the reversing and stability algorithm may include polling one or more angle sensors of the vehicle to determine the orientation of the vehicle relative to flat ground, which would indicate that the vehicle is travelling on a slope exceeding a pre-determined threshold. As used herein, an “angle sensor” may include, for example, an accelerometer, inclinometer, potentiometer or any other type of sensor located on a vehicle that is capable of detecting that a threshold slope angle has been encountered by the control system. For example, the threshold angle may fall within the range of approximately 15° to 20°, which is the threshold that would trigger the suspension system 10 entering the reversing and stability state 140. In step 402, if it is determined that the detected slope angle exceeds a threshold slope angle (for example 15°) has been detected, then at step 404 the suspension system 10 would instruct that fluid be added to the uphill lower (or B) chambers of the suspension springs that are located uphill relative to the other suspension springs, said fluid being added until the uphill B chambers have increased in pressure by approximately 10 to 20 pounds per square inch (psi). Once the uphill B chambers have been so pressurized, in step 404, at step 406 the angle sensors are polled to determine whether that angle is changed by, for example, in the range of 15° to 20°, or in the alternative, some other indicator or countdown timer may be utilized to detect when the correct amount of fluid has been added to the uphill B chambers. For example, for the algorithm illustrated in FIG. 10, fluid will be added to the uphill B chambers in small increments (about 10 to 20 psi) until the desired angle change, for example in the range of 15 to 20°, has been reached as determined in step 406. However, it will be appreciated that other methods for gradually increasing the pressure of the uphill B chambers may be utilized, such as a countdown timer activated in step 404 during which the pressure of the uphill B chambers is increased at a set rate for a set period of time before the angle sensor is again polled in step 406, so as to ensure stability of the vehicle 1 after the initial pressure adjustment is made in step 404, before continuing on to the next step 408 in the stabilization algorithm shown in FIG. 10. It will be appreciated that other such steps may occur between steps 404 and 408 illustrated in FIG. 10, and that the exact algorithm shown in FIG. 10 by way of example only is not intended to be limiting.

Once the uphill B chambers have been pressurized so as to meet the requirements of step 406 (in the illustrated example, an angle change in the range of 15 to 20°), at step 408 fluid is added to the downhill A chambers so as to fully extend those suspension springs, for example by pressurizing the A chambers of the downhill suspension springs in the range of approximately 200 psi. The incremental pressurization of the uphill B chambers (in step 404) accomplishes stiffening the corresponding uphill suspension springs, while fully pressurizing the downhill A chambers in step 408 accomplishes extending those suspension springs to their fullest amount of travel distance D, which thereby accomplishes leveling out the vehicle 1 to come within a certain levelling threshold, even when the vehicle itself is on a slope of 15° or more.

Once the pressure adjustments have been made to the downhill A chambers in step 408, at step 410 the angle sensors are again queried or polled and in step 412 the system determines whether the measured angles indicate that the vehicle has been sufficiently stabilized for traversing a slope, or otherwise whether the orientation of the vehicle meets a second threshold angle, thereby indicating that further adjustments are required to complete the stabilization process. In the case that the vehicle's orientation exceeds a second threshold angle at step 412, thereby indicating that the vehicle is not yet been stabilized, at step 414 the uphill A chambers may be depressurized and the uphill B chambers may be further pressurized, for example by substantially 20 to 40 psi, at the same time, thereby further stiffening the uphill suspension springs while at the same time lowering the uphill suspension springs so as to accomplish further leveling and stabilization of the vehicle 1 while on slope. In the event that, at step 412, it is determined that the second threshold angle is not met, thereby indicating that the vehicle is stable within acceptable threshold, then only the uphill A chambers are depressurized in step 416, thereby lowering the uphill suspension springs so as to further level vehicle but without stiffening the uphill suspension springs any further. In either case, after either step 414 or step 416 has taken place, the algorithm returns to step 400 is to once again poll the angle sensors and determine whether the reversing and stability state 140 is still required. As shown in FIG. 7, and as described earlier, when the vehicle control system is in state 140, once the reversing and stability of the vehicle have been achieved, in some cases such as where the vehicle continues to traverse over rough terrain while it is travelling on a slope, the suspension system 10 may then shift to state 120 where the leveling function takes over, or in other situations, such as where the vehicle is no longer traversing a slope, the state may revert back to the selected suspension setting 110.

### Pitch Control Function

The pitch control function may be useful for when the vehicle 1 is travelling quickly over terrain with sudden holes or cross ditches that may cause the front end of the vehicle 1 to dive downwardly and then the rear of the vehicle to kick upwardly, which may cause the vehicle to flip over its front end. When the system 10 is in the pitch control state 150, the suspension system is adjusted so as to help prevent the vehicle from flipping over its front end, by increasing the pressure in the front A chambers 20a, 22a thereby transferring weight toward the rear of the vehicle 1 and also minimizing the compression of the front springs 20, 22. At the same time, air or other fluid is added to the B chambers 30b, 32b of the rear springs 30, 32, which pulls down the rear of the vehicle and further assists in transferring weight toward the rear end of the vehicle 1.

### Cornering Assist Function

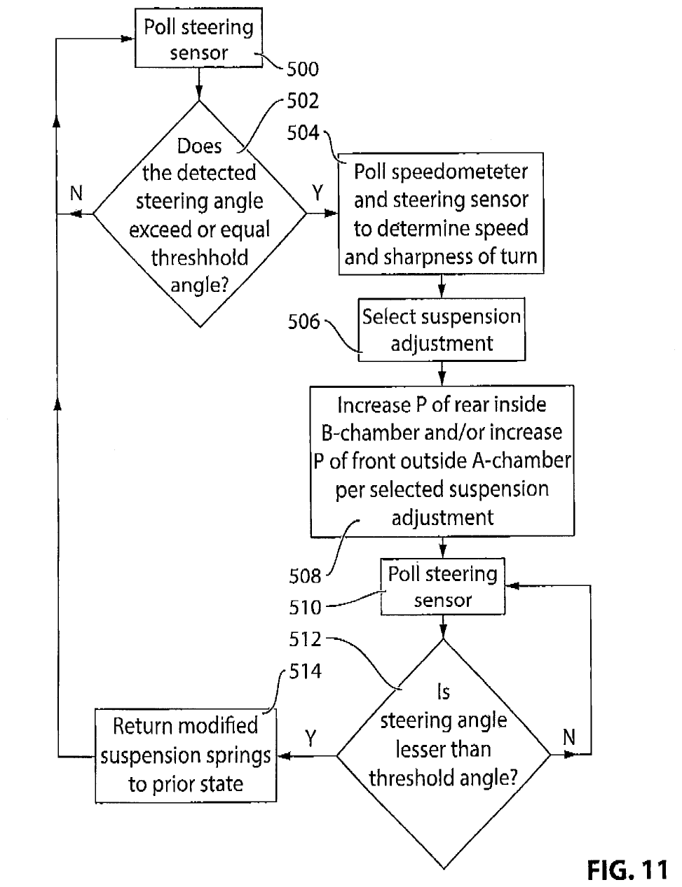

Regarding the cornering assist state 160, illustrated in FIG. 7, a cornering assist function algorithm is described and illustrated by way of example, with reference to FIG. 11. Step 500 of the cornering assist algorithm may involve polling a steering sensor to determine whether the vehicle 1 is entering into a turn. As used herein, a steering sensor may include one or more sensors which enable detection of a vehicle entering into or exiting a turn, and may include for example potentiometers or inclinometers which measure, for example, the angle of the steering differential relative to the wheel axle or the vehicle frame. Such examples of steering sensors are not intended in any way to be limiting, and it will be appreciated by persons skilled in the art that any type of sensor which is capable of detecting when a vehicle entering into or exiting from a turn are intended to be included within the scope of this disclosure and are referred to generally herein as a “steering sensor.”

At step 502, the algorithm may query whether the detected steering angle exceeds a given threshold angle which indicates that the vehicle entering into a turn. The threshold angle may be selected so as to control how sensitive the system 10 will be to changing directions of the vehicle, thereby triggering the system 10 to enter the cornering assist state 160; for example, a smaller threshold steering angle would ensure the state 160 is triggered when the vehicle makes slight changes in direction, whereas a larger threshold steering angle may be selected so as to only trigger the steering assist function when the vehicle is entering into a large turn. The polling of the steering sensor that occurs in step 500 may optionally include, in some embodiments of the present disclosure, polling the speedometer of the vehicle so as to adjust the triggering of the steering assist function by taking both the speed and the change of direction of the vehicle's travel into account. For example, at normal highway speeds, setting the threshold steering angle at lower limits as the trigger for entering the steering assist control function may be desirable because smaller adjustments to the steering angle at higher speeds will result in greater changes in direction. Furthermore, a higher speed of travel of the vehicle may require a greater adjustment to the suspension springs as a result of a greater centripetal force acting on the vehicle.

The applicant has found, in respect of the cornering assist functionality, that when a vehicle is entering into a turn, increasing the pressure of the rear inside corner B chambers of the suspension springs correlating to the rear inside corner wheel 2 of the vehicle 1 will have the effect of stiffening the suspension and increasing the spring rate of that suspension spring, thereby stabilizing the vehicle during the turn. By making such adjustments to the suspension spring, the applicant has found that the vehicle effectively leans into the corner, having an effect on the stability of the vehicle similar to banking the curve through which the vehicle is travelling. Optionally, in order to further cause the vehicle 1 to lean into the turn, increasing the pressure of the front outside A chamber of the adjustable suspension spring correlating to front outside corner wheel 2 of the vehicle 1 may further stabilize the vehicle by essentially extending the suspension spring on the front outside corner of the vehicle during the turn, thereby causing the vehicle to lean further into the curve. Although the optional adjustment of increasing the pressure of the front outside a chamber of the correlating suspension spring furthers the stability of the vehicle 1 during the turn, the applicant has found that this optional adjustment is not necessary and that the turn assist function may be adequately implemented by only increasing the pressure of the rear inside B chamber of the suspension spring correlating to the rear inside corner wheel of the vehicle.

Thus, once step 502 with the algorithm has determined that the steering angle exceeds the threshold indicating that the vehicle is entering a turn, the algorithm proceeds to step 504 where the speedometer and the steering sensor may again be polled to determine the speed and sharpness of the turn. However, step 504 may also be optional and the algorithm may work based on detecting the steering angle exceeding the threshold alone (at step 502), and then proceeding directly to step 506, in which step the specific suspension adjustments are selected based on the direction and magnitude of the turn. However, in embodiments where the speedometer is also polled at step 504 so as to include consideration of the vehicle's speed of travel in the calculation of the suspension adjustments to be made, as further described above, then both the speed and steering angle measured in step 504 are taken into account in selecting the suspension adjustments at 506. At step 508, the selected suspension adjustments are implemented by increasing the pressure in rear inside B chamber of the suspension spring correlating to the rear inside corner of the turning vehicle. For example, by way of illustration only, if a vehicle is turning right (from the perspective of the driver of vehicle), then the rear inside B chamber 32b, referring to FIG. 1, is pressurized in step 508; or for a vehicle turning left, the rear inside B chamber 30b of the vehicle would be pressurized in step 508, “inside” referring to the inside of the turn. Optionally, to further stabilize the vehicle 1 during a turn, step 508 may also include increasing the pressure of the front outside A chamber of the vehicle. For example, again taken from the driver's perspective, if the vehicle 1 were making a right-hand turn then the front outside tire would be controlled by adjustable suspension spring 20 and the step 508 would optionally include increasing the pressure of chamber 20a. To complete the illustrated example, not intending to be limiting in any way, if the vehicle were turning left then the outside front tire is controlled by adjustable suspension spring 22 and the adjustments that are optional in step 508 would include increasing the pressure of chamber 22a.

The algorithm would then proceed to step 510 where the steering sensor is again polled to determine when vehicle 1 has completed the turn. In step 512, once the measured steering angle falls below the threshold angle, indicating the vehicle has exited the turn, the algorithm proceeds to step 514 wherein the suspension springs would be adjusted to the state they were in immediately prior to the algorithm described in FIG. 11, for example with reference to FIG. 7, the corner assist state 160 would revert back to the selected suspension state 110.

### Sway Bar Function

With reference again to FIG. 7, sway bar setting state 170 involves configuring the suspension springs to as to reduce body roll when the vehicle is travelling at any height or speed, effectively behaving as a mechanical sway bar which may be advantageously engaged or disengaged by either selection of the sway bar setting state 170 by the user, or automatically engaging the sway bar state 170 by suspension system 10 when certain operating conditions of the vehicle are met; for example, in situations where the vehicle 1 is travelling at a moderate speed over moderate to difficult terrain thereby increasing the possibility of the vehicle rolling during travel.

When suspension system 10 enters sway bar state 170, the pressure is increased in all of the B chambers in each of the air spring 20b, 22b, 30b and 32b by an equal amount. Optionally, in some embodiments of the sway bar state 170, the rear B chambers 30b, 32b may have slightly greater pressures than the front B chambers 20b, 22b, depending on the preference of the driver or user of the vehicle and the vehicle performance required. The applicant observes that the sway bar setting adjustments to the suspension spring B chambers, described herein, has the effect of firming or stiffening the suspension springs, causing them to travel less when the vehicle travels over uneven terrain and thereby stabilizing the vehicle and reducing the roll of the vehicle when travelling at moderate speeds over moderately rough terrain.

### Crossover Function

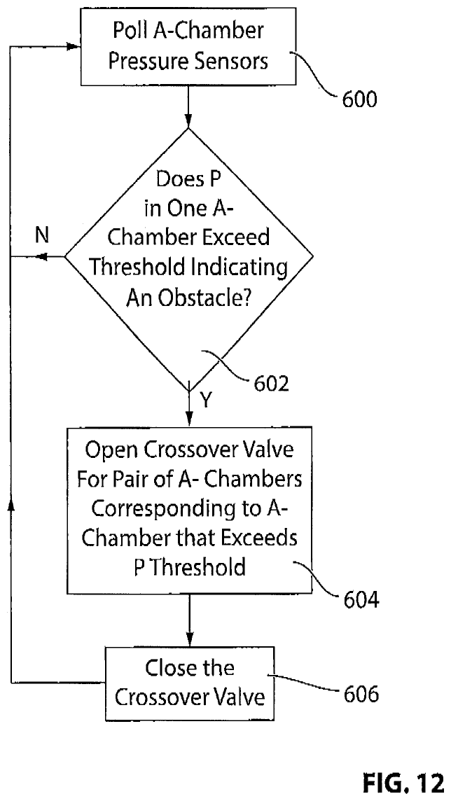

Finally, suspension system 10 may also include a crossover state 180, an example of an algorithm for which is provided in FIG. 12. The crossover state 180 requires at least one crossover fluid line 43 between the upper chambers (or A chambers) of two adjacent suspension springs, as illustrated for example in FIG. 2, showing a crossover valve 41 and a crossover line 43 between A chambers 20a, 22a, and a second crossover valve 41 and crossover line 43 between A chambers 30a, 32a. The applicant has observed that the crossover function is most useful between the two front suspension springs 20, 22, but a second crossover line 43 and valve 41 may optionally be provided to selectively link the upper or A chambers 30a, 32a.

In the crossover state 180, the one or more crossover valves 41 may be selectively opened so as to allow fluid communication between the upper chambers connected by a crossover line, such as between 20a, 22a or between 30a, 32a. Opening the crossover valve 41 enables the pressure to become balanced as between the A chambers connected by the crossover line 43 and the open crossover valve 41. The crossover function 180 may be particularly useful for example in situations where one wheel encounters a very large obstacle, thereby exerting an upward force on that one wheel and corresponding suspension spring, thereby increasing the pressure of the A chamber in that spring. In such situations, it is helpful to equalize the pressure between the suspension spring encountering the obstacle and the adjacent suspension spring on the same axle of the vehicle, so as to lower the pressure of the A chamber of the suspension spring that is crossing over the obstacle while at the same time increasing the pressure in the A chamber of the adjacent suspension spring on the other side of the axle. Doing so has the effect of lowering the corner of the vehicle that is crossing over the obstacle, while at the same time, by virtue the pressurizing the adjacent A chamber, the opposite wheel which may not have much or any traction may be brought into contact with the ground. In the applicant's experience in been found that such a crossover function is particularly useful for the front axle of the vehicle 1, however, in some situations it may also be useful to use the crossover function on the rear axle of the vehicle; however this is optional and not required to achieve the desired result being able to cross over most obstacles.

An example of an algorithm for carrying out the crossover function in state 180 is illustrated in FIG. 12. For example, when the suspension system 10 is in the crossover state 180, the algorithm at step 600 may poll the A chamber pressure sensors, and at step 602 if it is determined that pressure in any one of the A chambers exceeds a given threshold that indicates the corresponding wheel to for that particular suspension spring is crossing a large obstacle, the algorithm would then proceed to step 604 at which point the suspension system 10 instructs the crossover valve 41 for the pair A chambers corresponding to the A chamber that exceeded the pressure threshold in step 602 to open, thereby allowing the pressure of the interconnected A chambers to equalize. The crossover algorithm then proceeds to step 606 whereby the suspension system 10 instructs crossover valve 41 to close. At that point in time, crossover state 180 may then revert back the selected suspension setting state 110 until the threshold chamber A pressure is once again detected, causing the suspension system 10 to again enter the crossover state 180.

What is claimed is:

1. An active suspension control system for individually controlling a suspension assembly of each corresponding wheel assembly of a plurality of wheels of a vehicle in response to driving conditions, the control system comprising:
a plurality of suspension assemblies corresponding to the plurality of wheels, each suspension assembly of the plurality of suspension assemblies including an adjustable suspension spring,
each adjustable suspension spring of the plurality of suspension assemblies including a hollow, fluidically sealed cylinder and a piston having a shaft and a head, the piston cooperating within the cylinder, the cylinder having an upper chamber divided from a lower chamber by the piston head, the lower chamber being adjacent to the piston shaft coupled to the corresponding wheel assembly,
each chamber of the upper and lower chambers of the suspension spring having a port fluidly coupled to a fluid line and a valve of a valve assembly, wherein a first end of the fluid line is fluidly coupled to the port and a second end of the fluid line is coupled to the valve,
the valve assembly operatively coupled to an electronic controller to control each valve of the valve assembly and a fluid source fluidly coupled to each valve of the valve assembly,
wherein the extension or retraction of each adjustable suspension spring is controlled by selectively introducing and/or removing a volume of a fluid from the upper and/or lower chambers of said adjustable suspension spring through the fluid line.

2. The active suspension control system of claim 1 wherein each suspension assembly of the plurality of suspension assemblies further includes an adjustable damper.

3. The active suspension control system of claim 1 wherein the fluid is selected from a group comprising: compressed CO₂, compressed air, hydraulic fluid, compressed gas.

4. The active suspension control system of claim 1 further comprising at least one crossover fluid line selectively fluidly coupling an upper chamber of a first adjustable suspension spring to an upper chamber of a second adjustable suspension spring, each crossover fluid line of the at least one crossover fluid line including a crossover valve operatively coupled to the crossover fluid line and to the electronic controller so as to selectively open or close the crossover valve to allow equalization of a pressure of the upper chambers of the first and second adjustable suspension springs.

5. A method of controlling an active suspension system of a vehicle having a plurality of wheels, the active suspension system including a suspension assembly corresponding to each wheel assembly of each wheel of the plurality of wheels, the method steps comprising:
providing a suspension assembly corresponding to each wheel assembly, each suspension assembly including an adjustable suspension spring having a hollow, fluidically sealed cylinder and a piston having a shaft and a head, the piston cooperating within the cylinder, the cylinder having an upper chamber divided from a lower chamber by a piston head, the lower chamber being adjacent to the piston shaft coupled to the corresponding wheel assembly, each chamber of the upper and lower chambers of the suspension spring having a port selectively fluidly coupled to a fluid supply through a fluid line and a valve of a valve assembly, the valve assembly operatively coupled to an electronic controller to control each valve of the valve assembly,
receiving one or more control inputs into the electronic controller,
generating one or more control outputs, each control output of the one or more control outputs including an instruction to one or more valves of the valve assembly to open or close so as to add a fluid of the fluid supply to or remove the fluid from the upper or lower chamber of one or more adjustable suspension springs,
applying the one or more control outputs by the electronic controller to the one or more valves of the valve assembly.

6. The method of claim 5 wherein the one or more control inputs are selected from a group comprising: signals transmitted by one or more sensors of the vehicle, one or more user-selected pre-set modes.

7. The method of claim 6 wherein the one or more pre-set modes is selected from a group comprising: two wheel drive (2WD) ride height for normal highway speed driving conditions, 2WD ride height for high speed driving conditions, four wheel drive (4WD) high range ride height, 4WD low range ride height for medium speed driving conditions, 4WD low range ride height for low speed high clearance driving conditions, 4WD low range ride height for high speed cross ditch driving conditions.

8. The method of claim 5, further including the steps of:
receiving one or more control inputs wherein the one or more control inputs include one or more level signals transmitted by one or more level sensors mounted to the vehicle indicating a first spatial orientation of the vehicle and a plurality of pressure signals transmitted by a plurality of pressure sensors, each pressure signal of the plurality of pressure signals indicating a pressure of each of the upper and lower chambers of each adjustable suspension spring of the vehicle,
generating one or more leveling control outputs, each control output of the one or more control outputs including an instruction to the one or more valves to add or remove the fluid from an upper or lower chamber so as to change the orientation of the vehicle to a second spatial orientation,
repeating the above steps until a target spatial orientation of the vehicle is obtained.

9. The method of claim 8 wherein the target spatial orientation includes a level orientation.

10. The method of claim 9 further including the steps of:
confirming that the level orientation of the vehicle is obtained,
receiving one or more signals form one or more pressure sensors indicating an initial pressure of each upper chamber of each adjustable suspension spring,
generating one or more pressure balancing control outputs, each control output of the one or more pressure balancing outputs including an instruction to the one or more valves to add or remove fluid from at least one upper chamber so as to change the initial pressure of the upper chamber to a final pressure, wherein the final pressure of each upper chamber is equal to the final pressure of the other upper chambers.

11. The method of claim 6 wherein the one or more sensors of the vehicle includes at least one angle sensor configured to detect an angle of a frame of the vehicle relative to flat ground wherein the method further includes the steps of:
detecting the angle wherein the angle exceeds a first threshold value,
generating a stability control signal to add a first volume of fluid to an uphill set of lower chambers wherein the uphill set of lower chambers has an uphill elevation relative to a downhill set of one or more lower chambers,
applying the stability control signal to add the first volume fluid to the uphill set of lower chambers so as to change the angle to a first modified angle, the first modified angle being within a pre-determined range of angles,
generating an extension control signal to add a second volume of fluid to the downhill set of upper chambers so as to fully extend the adjustable suspension springs having the downhill set of upper chambers,
applying the extension control signal so as to add the second volume of fluid to the downhill set of upper chambers so as to obtain a maximum pressure threshold in the downhill set of upper chambers and fully extend the adjustable suspension springs having the downhill set of upper chambers and so as to change the angle to a modified angle,
detecting the modified angle,
generating a leveling control signal to at least depressurize the uphill set of upper chambers,
applying the leveling control signal so as to decrease the modified angle.

12. The method of claim 11 wherein the pre-determined range of angles is substantially 15° to 20°.

13. The method of claim 11 wherein the step of generating a leveling control signal to at least depressurize the uphill set of upper chambers further includes adding a third volume of fluid to the uphill set of lower chambers.

14. The method of claim 6 wherein the one or more sensors of the vehicle includes a steering sensor configured to detect an orientation of an axle of the vehicle relative to a longitudinal axis extending through the vehicle, the method further comprising the steps of:
detecting the orientation of the axle,
determining whether the orientation exceeds a threshold value indicating that the vehicle is turning,
identifying an inside rear suspension assembly,
generating a cornering signal to add a volume of fluid to the lower chamber of the inside rear suspension assembly at a selected rate,
applying the cornering signal so as to increase a pressure of the lower chamber of the inside rear suspension assembly at the selected rate,
determining whether the detected orientation falls below the threshold value,
generating a cornering ended signal to remove the volume of fluid from the lower chamber of the inside rear suspension assembly at the selected rate,
applying the cornering ended signal so as to decrease the pressure of the lower chamber of the inside rear suspension assembly at the selected rate.

15. The method of claim 14 wherein the one or more sensors of the vehicle further includes a speedometer configured to indicate the speed of the vehicle and wherein the step of detecting the orientation of the axle further includes detecting the speed of the vehicle and wherein the step of generating the cornering signal to add the volume of fluid to the lower chamber of the inside rear suspension assembly at the selected rate includes selecting the selected rate based upon both the detected orientation and the detected speed of the vehicle.

16. The method of claim 14 wherein the step of identifying the inside rear suspension assembly further includes identifying the outside front suspension assembly and wherein the steps of generating and applying the cornering signal further includes adding a second volume of fluid to the upper chamber of the outside front suspension assembly so as to increase the pressure of the outside front suspension assembly at a second selected rate and wherein the steps of generating and applying the cornering ended signal further includes removing the second volume of fluid from the upper chamber of the outside front suspension assembly at the second selected rate so as to decrease the pressure of the upper chamber of the outside front suspension assembly.

17. The method of claim 6 wherein the one or more user-selected pre-set modes includes a pitch control mode wherein a first volume of fluid is added to each upper chamber of the one or more suspension assemblies located adjacent to a front end of the vehicle and a second volume of fluid is added to each upper chamber of the one or more suspension assemblies located adjacent to a rear end of the vehicle when the pitch control mode is selected.

18. The method of claim 6 wherein the one or more sensors of the vehicle includes a plurality of pressure sensors, each pressure sensor of the plurality of pressure sensors configured to detect a pressure in the upper chamber of the adjustable suspension spring of each suspension assembly of the vehicle, and wherein the upper chambers of the adjustable suspension springs of each pair of opposing suspension assemblies are selectively fluidly coupled by a corresponding crossover fluid line and crossover fluid valve, the method further comprising the steps of:
detecting a pressure of the upper chamber of each adjustable suspension spring,
determining whether the detected pressure of any one upper chamber exceeds a threshold pressure indicating that the suspension spring corresponding to the one upper chamber is being acted upon by an obstacle,
applying a crossover signal to the corresponding crossover valve corresponding to the one upper chamber so as to open the crossover valve providing fluid communication between the upper chambers of the pair of opposing suspension assemblies and equalize the pressure between said upper chambers,
applying an end crossover signal to the corresponding crossover valve so as to close the corresponding crossover valve and stop fluid communication between the upper chambers of the pair of opposing suspension assemblies.

19. The method of claim 18 wherein the one or more sensors of the vehicle further includes a plurality of angle sensors configured to detect an angle between a suspension arm of each suspension assembly of the vehicle and a frame of the vehicle, and wherein the step of determining whether the detected pressure of any one upper chamber exceeds a threshold pressure indicating that the suspension spring corresponding to the one upper chamber is being acted upon by an obstacle further includes detecting an initial angle between suspension arm of the suspension spring corresponding to the one upper chamber being acted upon by the obstacle and the frame of the vehicle, and wherein the method further includes the steps of:
detecting an intermediate angle between the suspension arm of the suspension spring corresponding to the one upper chamber being acted upon by the obstacle and the frame of the vehicle,
comparing the intermediate angle against the initial angle to determine when the intermediate angle has decreased so as to be lesser than the initial angle,
the above steps to take place before the step of applying an end crossover signal to the corresponding crossover valve so as to close the corresponding crossover valve and stop fluid communication between the upper chambers of the pair of opposing suspension assemblies.

20. The method of claim 6 wherein the one or more user-selected pre-set modes includes at least one sway bar mode wherein the pressure of the lower chambers of each adjustable suspension spring of the vehicle is increased by at least a first pre-determined amount.

21. The method of claim 20 wherein the at least one sway bar mode includes first and second sway bar modes, wherein the first sway bar mode includes an instruction to increase the lower chambers of each adjustable suspension spring by a plurality of pre-determined amounts, the plurality of pre-determined amounts selected so as to provide a final pressure in the lower chamber of each adjustable suspension spring that is equal to a final pressure in the lower chamber of each of the other adjustable suspension springs, and the second sway bar mode includes an instruction to increase the pressure of the lower chambers of a pair of rear adjustable suspension springs by a rear amount that is greater than a front amount of pressure increase of the lower chambers of a pair of front adjustable suspension springs.
